(19) United States
(12) Patent Application Publication
(10) Pub. No.: US 2005/0050560 A1
(43) Pub. Date: Mar. 3, 2005

(54) Disk device provided with tray removal prevention mechanism

(76) Inventor: Masahiko Nishide, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/923,796

(22) Filed: Aug. 24, 2004

(30) Foreign Application Priority Data
Aug. 28, 2003 (JP) 2003-209235

(51) Int. Cl. G11B 17/03

(52) U.S. Cl. 720/610

(57) ABSTRACT

To provide a disk device provided with a tray removal prevention mechanism which can easily perform mounting and dismounting of a tray in a short time with a simple mechanism while preventing deformation and rupture of the tray, the tray removal prevention mechanism includes opening portions respectively formed on both sides of a rear portion of the tray, resiliently deformable arms extending from rear end edges of the opening portions, the arm having a hook portion having a contact surface on a front surface thereof in a distal end portion, the hook portion having an engagement release lever erected upwardly, and stoppers formed on a device body side with which the contact surfaces of the hook portions are brought into contact, thereby preventing the removal of the tray from the device body when the tray is unloaded.

### BACKGROUND OF THE INVENTION

1. Field of the Invention

The present invention relates to a disk device provided with a tray removal prevention mechanism which performs reproduction or recording of an optical disk or magneto optical disk such as a CD, a DVD, an MD or the like, and, more particularly to a disk device provided with a tray removal prevention mechanism which prevents the failing of a tray which mounts a disk thereon and moves between a reproduction position arranged in a body and an exchange position where the mounting or the dismounting of the disk is performed.

2. Related Art

A disk device to reproduce a disk such as a CD, a DVD or the like is constituted of a tray to perform loading and unloading of the disk by mounting the disk thereon, a drive part to rotate the disk, a pickup and a feeding device to move the pickup. The disk device includes motors necessary for the movements of these respective constitutional parts and these motors are controlled so that these constitutional parts can perform the necessary operations respectively.

Also in case that the tray mounts the disk thereon and unloads the disk from a device body or loads the disk, the tray is driven by a motor. To drive the tray by the motor, a gear is meshed with a rack formed on a side portion of the tray and the gear is rotatably driven by the motor. Accordingly, in case that the tray in the disk exchange position is to be loaded into the inside of the device body, the motor is driven by turning on a manipulation button or the motor is driven by turning on a switch by pushing a distal end of the tray so as to slightly retract the tray.

Further, to stop the tray at a given position thus preventing the removal or the falling of the tray from the device body at the time of unloading the tray, a stopper is provided to the disk device. A “disk device” disclosed in JP-A-2003-196907 is configured such that a hook-shaped tray pusher is provided and the hook-shaped tray pusher is deflected in the lateral direction thus allowing the loading of a tray on mounting the tray into the device body. With respect to groove portions of the tray and rails of the device body, by forming portions to be engaged with each other when the tray is pulled out into a tapered shape, it is possible to stop the tray at a pulled-out end due to a frictional force between the tapered rails and the tapered groove portions.

Accordingly, due to the frictional force between the tapered groove portions formed on the tray side and the tapered rails formed on the device body side, it is possible to stop the tray in a stable manner at the pulled-out end by decelerating the tray. Further, it is possible to easily mount the tray from the vertical direction by forcibly expanding the hook-shaped pusher formed on the device body side and hence, it is possible to prevent the falling or removal of the tray at the disk exchange position due to the engagement of the tapered groove portions and the tapered rails.

Incidentally, although the mounting of the tray can be easily performed from the vertical direction of the device body in the above-mentioned structure, once the tray is mounted, it is difficult to remove the tray and hence, the operability at the time of repair and maintenance is poor. Accordingly, due to the operation to forcibly expand the hook-shaped pusher at the time of mounting the tray and the difficulty at the time of removing the tray, the assembling and disassembling of the device requires a considerable time and, at the same time, since the tray is mounted by forcibly expanding the hook-shaped pusher, there exists a possibility that the hook-shaped pusher is deformed or broken leading to the malfunction of the device.

Further, since the pushing and separating operation of the tapered groove portions and the tapered rails is repeatedly performed using the power of the motor, an excessively large load is applied to the gear and the rack which perform the power transmission and hence, it causes chipping of gear teeth or breakage of the parts thus remarkably lowering the lifetime of the disk device as a whole. Furthermore, to fix the timing and position of the engagement between the tapered groove portions and the tapered rails, it is necessary to ensure the high dimensional accuracy at the time of forming parts by molding thus lowering the productivity in the mass production.

FIG. 5 shows a disk device provided with a conventional tray removal prevention mechanism. A hook portion (b) is formed on a backside portion of the tray (a) and a stopper (c) is formed on a device body side. Here, to prevent the removal of the tray (a) even when the tray (a) is pulled in case the tray (a) is unloaded to the disk exchange position, the hook portion (b) is brought into contact with the stopper (c).

FIG. 6 and FIG. 7 are enlarged views showing the above-mentioned hook portion (b) and stopper (c), wherein when the tray (a) is pulled out, a contact surface (d) of the hook portion (b) is brought into contact with the stopper (c). However, due to an impact to be generated when the hook portion (b) is brought into contact with a stopper (c), an arm (e) is deformed by deflection thus giving rise to a case in which the arm (e) is removed from the stopper (c). On the other hand, since the hook portion (b) is formed on only one side of a rear portion of the tray (a), the balance of force to be generated when the hook portion (b) is stopped due to the contacting thereof with the stopper (c) is collapsed and hence, the tray (a) is twisted.

### SUMMARY OF THE INVENTION

In this manner, the tray removal prevention mechanism in the conventional disk device has the above-mentioned drawbacks. It is an object of the present invention to overcome these drawbacks and to provide a disk device provided with a tray removal prevention mechanism which can easily perform mounting and dismounting of a tray in a short time with an extremely simple mechanism, can prevent deformation and breakage of the tray at the time of mounting the tray, and can prolong the lifetime of the disk device by reducing a load applied to drive-system parts attributed to the transfer of the tray.

In a disk device provided with a tray removal prevention mechanism according to the present invention, the tray removal prevention mechanism comprises rectangular opening portions respectively formed on both sides of a rear portion of a tray, resiliently deformable arms extending from rear end edges of the opening portions, the arm having a hook portion having a contact surface on a front surface thereof in a distal end portion, the hook portion having an engagement release lever erected upwardly, and stoppers formed on a device body side with which the contact surfaces of the hook portions are brought into contact, whereby the tray is not removed from the device body when the tray is unloaded. Although the hook portions formed on the tray are stopped immediately before the hook portions are brought into contact with the stoppers, due to the above-mentioned constitution, when the tray is pulled out, the contact surfaces of the hook portions are respectively brought into contact with the stoppers provided on both sides and hence, there is no possibility that the tray is removed from the device body due to the twisting thereof. Further, the tray can be easily mounted or dismounted by pushing the engagement release levers in the lateral direction.

Wall surfaces extending downwardly are formed on peripheries of each opening portion and the arm is formed on lower portion of the rear end wall surface extending therefrom. Due to such a constitution, it is possible to ensure the mounting portions of the arms and the arms perform a role as reinforcing members to prevent the distortion of the tray surfaces due to the openings.

Each of the arms may have a projecting portion being projected to distal end side from the hook portion so that the engagement release lever can be pushed inwardly until the projecting portion is brought into contact with the wall surface. Once the projecting portion is brought into contact with the wall surface, the bending deformation of the arm can be suppressed. That is, there is no possibility that the arm is broken due to the bending.

Upper end of each stopper is arranged to be positioned lower than lower ends of the peripheral walls of the opening portion, the contact surface of the hook portion form a vertical surface extended downwardly to be able to be in contact with at least the stopper, and a tapered inclined surface is formed on a backside surface of the hook portion. Due to such a constitution, after mounting the tray on the device body, the stoppers are brought into contact only with the contact surfaces of the hook portions so that the removal of the tray is prevented, while at the time of mounting the tray on the device body, when the stoppers are brought into contact with the inclined surfaces of the back sides of the hook portions, it is possible to store the tray by inserting while bending the arms.

### BRIEF DESCRIPTION OF THE DRAWING

FIG. 1 is a plan view showing a tray in an unloaded state in an embodiment of a tray removal prevention mechanism according to the present invention;

FIG. 2 is perspective view showing the tray removal prevention mechanism in a portion A in FIG. 1 in an enlarged manner;

FIG. 3(a) and FIG. 3(b) are explanatory views of the above-mentioned tray removal prevention mechanism, wherein FIG. 3(a) is a plan view of the tray removal prevention mechanism and FIG. 3(b) is a longitudinal cross-sectional view of the tray removal prevention mechanism;

FIG. 4 is a plan view showing a state in which an arm of the tray removal prevention mechanism is deformed in a curved shape;

FIG. 5 is a plan view of a disk device provided with a conventional tray removal prevention mechanism;

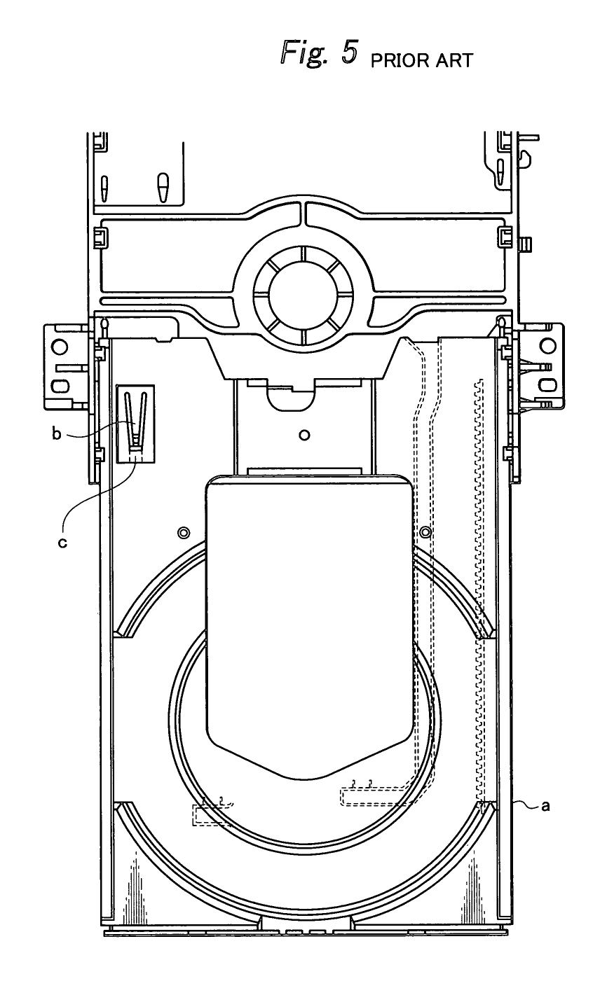

FIG. 6 is a perspective view of the above-mentioned tray removal prevention mechanism; and

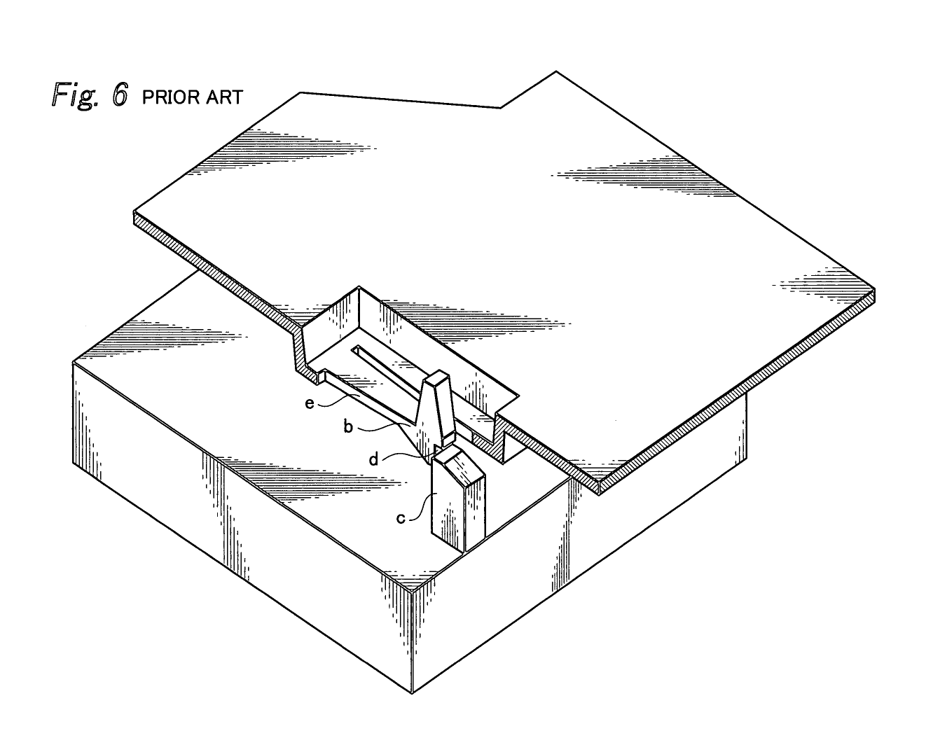

FIG. 7 is a longitudinal cross-sectional view of the above-mentioned tray removal prevention mechanism.

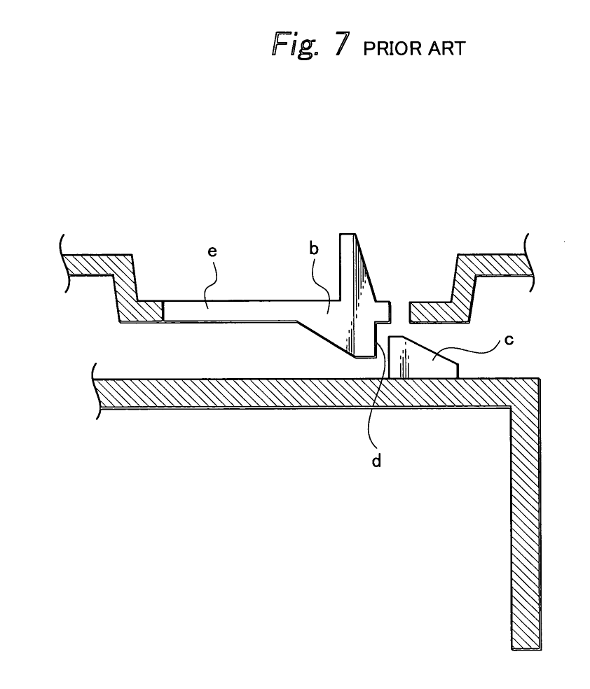

### DETAILED DESCRIPTION OF PREFERRED EMBODIMENT

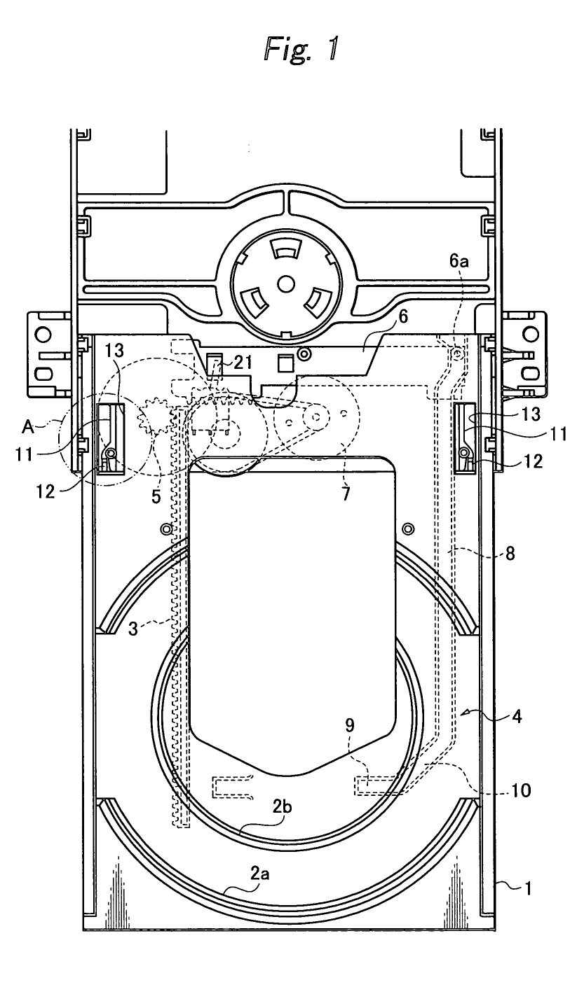

Preferred embodiment of a disk device according to the present invention is explained in detail in conjunction with drawings hereinafter. FIG. 1 shows a tray 1 in a state that the tray 1 assumes a disk exchange position after being unloaded. As shown in the drawing, circular shallow recessed portions 2a, 2b are formed on an upper surface of the tray 1 and a disk is set by fitting into the recessed portions 2a, 2b. A rack 3 is formed in the fore-and-aft direction on a lower-surface side of the tray 1, and an approximately L-shaped guide groove 4 is formed along the rack 3. A pinion 5 is meshed with the rack 3, while a guide pin 6a is mounted on a cam rod 6 in a projecting manner and is loosely fitted into the guide groove 4.

The pinion 5 is rotatably driven by a motor 7 and, the rack 3 and the tray 1 are retracted and are loaded into the inside of the device due to the rotation of the pinion 5. While the tray 1 is opened and dosed by advancing and retracting by a fixed distance, the approximately L-shaped guide groove 4 is formed of a longitudinal guide groove 8 arranged parallel to the rack 3, a lateral guide groove 9 arranged perpendicular to the rack 3 and a corner guide groove 10 communicating with between the longitudinal guide groove 8 and the lateral guide groove 9 in an oblique manner. Further, a rear end portion of the guide groove 8 is extended in a curved manner.

A switch 21 to start or stop the motor 7 is mounted such that the motor 7 is operated in response to the detection of the left-and-right movement of the cam rod 6. That is, when the tray 1 is unloaded and advances to the disk exchange position, the guide pin 6a loosely fitted in the longitudinal guide groove 8 arrives at the curved portion and, when the cam rod 6 is moved in the right direction on the drawing, the switch 21 is turned off so that the tray 1 is stopped. On the other hand, when the tray 1 is loaded and is retracted, the guide pin 6a loosely fitted into the guide groove 8 arrives at the corner guide groove 10 and the cam rod 6 moves in the left direction on the drawing and hence, the switch 21 is turned off and the tray 1 is stopped.

With respect to the tray 1, when an ejection button mounted on a front panel is pushed, the motor 7 is started and the pinion 5 is rotated so that the rack 3 is advanced and the tray 1 is unloaded, wherein the cam rod 6 acts on the switch 21 as mentioned above and hence, the tray is stopped at the disk exchange position. Here, the disk device is provided with a tray removal prevention mechanism to prevent removal or falling of the tray 1 from a device body. The tray removal prevention mechanism is provided to both sides at a rear portion of the tray 1 respectively (see a portion “A” in FIG. 1).

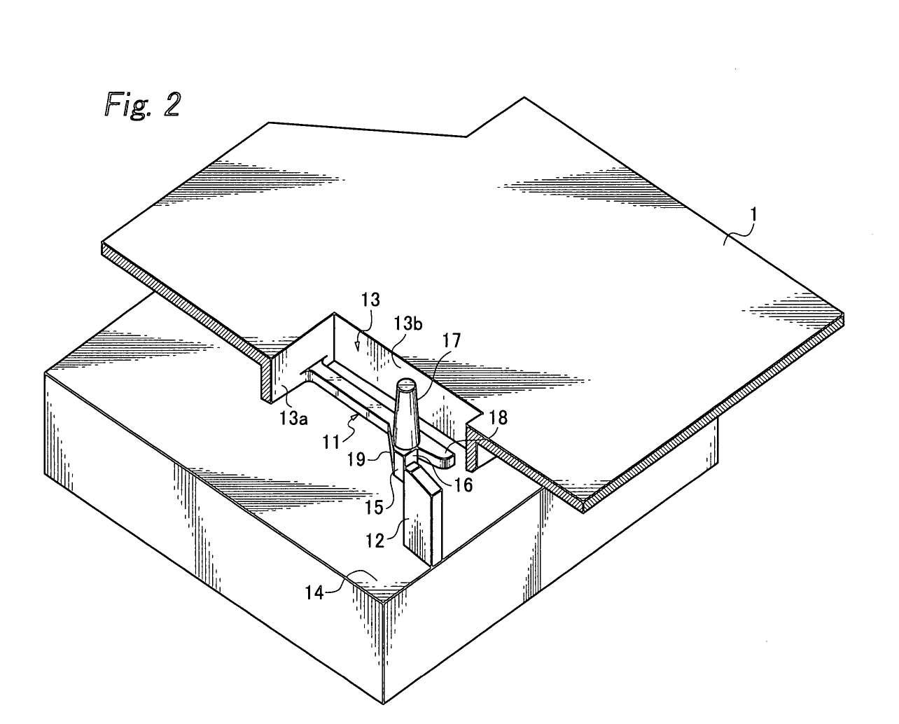

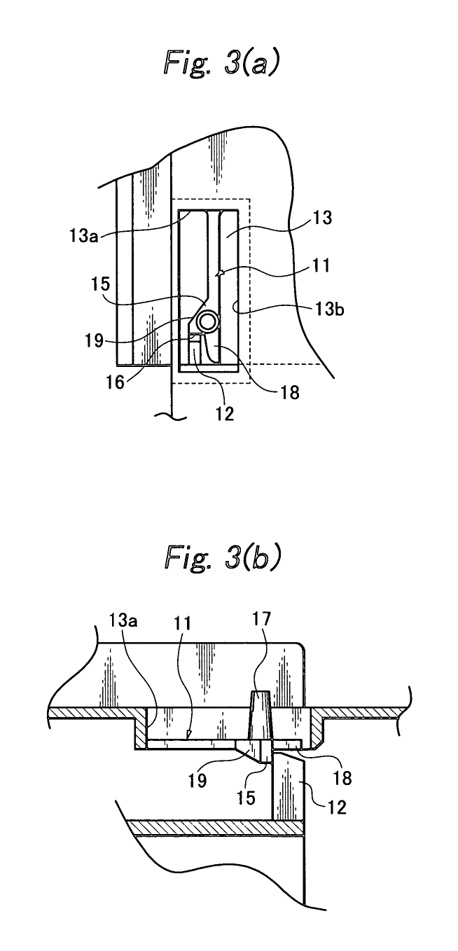

The tray removal prevention mechanism is configured as shown in FIG. 2 to FIG. 4. That is, rectangular opening portions 13 are respectively formed at both sides at the rear portion of the tray 1 and, at the same time, a wall surface extending downwardly in a rectangular sleeve shape is formed on a periphery of each opening portion. A resiliently deformable arm 11 is formed on a lower portion of a backside wall surface 13a in an extending manner A stopper 12 is formed on a body frame 14 in a projecting manner, which is brought into contact with the arm 11. A hook portion 15 having a vertical contact surface 16 is formed on a distal end portion of the arm 11. An engagement release lever 17 is formed on an upper surface of the hook portion 15 erecting upwardly, and projecting portion 18 is formed further projecting to a distal end side from the hook portion 15. Since the arm 11 is formed on a lower portion of the backside wall surface 13a, the engagement release lever 17 merely projects upwardly from the tray 1 slightly while ensuring a sufficient length for manipulation. Further, the arm 11 is formed to be easily bent in the lateral direction by setting a ratio of a width relative to a thickness of its barrel portion to a relatively small value.

The stopper 12 has an upper end thereof arranged to be positioned slightly lower than lower ends of peripheral walls 13a, 13b of the opening portion 13. The hook portion 15 is bulged downwardly and laterally such that the contact surface 16 formed on the front surface side forms a vertical surface to be engageable with the stopper 12. Further, the hook portion 15 forms a tapered inclined surface 19 on a backside surface of the contact surface 16. Accordingly, owing to the engagement of the tray 1 with the stopper 12, there is no possibility that the tray is removed or fallen from the device body even when it is pulled.

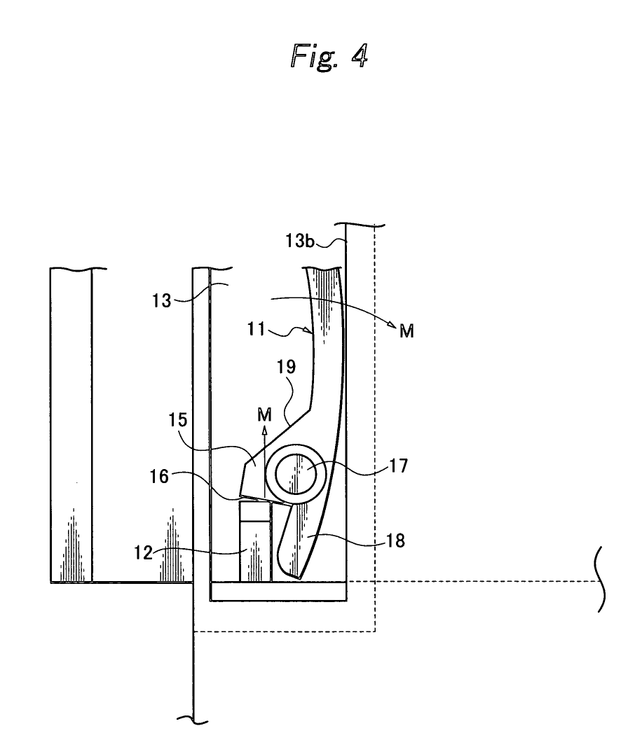

According to the tray removal prevention mechanism having such a constitution, when the contact surface 16 of the hook portion 15 is brought into contact with the stopper 12, as shown in FIG. 4, a reaction force P is generated and this reaction force P induces a moment M to curve the arm 11. When the arm 11 is curved in an arcuate shape in this manner, the arm 11 is bulged inwardly and is brought into contact with the wall surface 13b of the side edge of the opening portion 13 and hence, the further curving deformation can be suppressed. When the curved arm 11 is not brought into contact with wall surface 13b and the curving deformation is not suppressed, the hook portion 15 and the contact surface 16 slip from each other and hence, the hook portion 15 is removed from the stopper 12. That is, because of providing the arm 11 which forms the hook portion 15 on the distal end thereof in the inside of the opening portion 13, there is no possibility that the hook portion 15 is removed from the stopper 12.

To remove the tray 1 from the device body, an operator pinches the engagement release lever 17 erected upwardly from the hook portion 15 and swings it inwardly to bend the arm 11 thus removing the hook portion 15 from the stopper 12. Here, since the projecting portion 18 extends from the hook portion 15 in the distal end direction, a distal end of the projecting portion 18 is brought into contact with the wall surface 13b. That is, it is possible to push the engagement release lever 17 inwardly until the projecting portion 18 is brought into contact with the wall surface 13b and, due to the contacting of the projecting portion 18 with the wall surface 13b, the further bending deformation of the arm 11 can be suppressed and hence, there is no possibility that the arm 11 is broken due to the bending.

In this manner, the hook portion 15 is removed from the stopper 12 by bending the arm 11 inwardly, and hence, the tray 1 can be removed from the device body. On the other hand, in mounting the tray 1 in the device body, the tray 1 is inserted into the tray storing space, and the inclined surface 19 of the hook portion 15 is brought into contact with the stopper 12. When the tray 1 is continuously pushed, the stopper 12 slides on the inclined surface 19 while bending the arm 11 and reaches the contact surface 16. At this point of time, the arm 11 returns to the original linear position and the tray 1 is stored. Once the tray 1 is stored, the contact surface 16 of the hook portion 15 is engaged with the stopper 12 and hence, the tray 1 is not removed.

The tray removal prevention mechanism according to the present invention having the above-mentioned constitution can obtain following advantageous effects.

That is, since the contact surfaces of the hook portions are respectively brought into contact with the stoppers formed at both sides of the rear portion of the tray, it is possible to provide the disk device provided with the safe tray removal prevention mechanism which can prevent the removal of the tray from the device body attributed to the twisting of the tray.

Since the tray can be easily mounted or dismounted with the simple manipulation by pushing the engagement release lever in the lateral direction and the excessive bending can be prevented, it is possible to provide a useful disk device provided with the tray removal prevention mechanism which can prevent the deformation and the rupture at the time of mounting the tray.

1. A disk device provided with a tray removal prevention mechanism for a tray which mounts a disk thereon and is movable between a reproduction position in a device body and an exchange position where mounting and dismounting of the disk is performed, wherein the tray removal prevention mechanism comprising:
opening portions respectively formed on both sides of a rear portion of the tray, resiliently deformable arms extending from rear end edges of the opening portions, the arm having a hook portion having a contact surface on a front surface thereof in a distal end portion, the hook portion having an engagement release lever erected upwardly, and
stoppers formed on a device body side with which the contact surfaces of the hook portions are brought into contact.

2. A disk device according to claim 1, wherein wall surfaces extending downwardly are formed on peripheries of each opening portion and the arm is formed on lower portion of the rear end wall surface extending therefrom.

3. A disk device according to claim 1, wherein each arm has a projecting portion being projected to distal end side from the hook portion.

4. A disk device according to claim 3, wherein upper end of each stopper is arranged to be positioned lower than lower ends of the peripheral walls of the opening portion, the contact surface of the hook portion form a vertical surface extended downwardly to be able to be in contact with at least the stopper, and a tapered inclined surface is formed on a backside surface of the hook portion.
